(19) United States
(12) Patent Application Publication
(10) Pub. No.: US 2011/0109882 A1
(43) Pub. Date: May 12, 2011

(54) Topper for an Entertainment Machine

(75) Inventors: James Cove, Blakeshall (GB); Richard Loffler, Caterham (GB)

(73) Assignee: Gamesman Limited, Crawley (GB)

(21) Appl. No.: 12/943,731

(22) Filed: Nov. 10, 2010

(30) Foreign Application Priority Data
Nov. 11, 2009 (GB) 0919714.6

(51) Int. Cl. G03B 21/10; G03B 21/62

(52) U.S. Cl. 353/30; 359/460; 353/79; 353/94; 353/122; 359/451

(57) ABSTRACT

A topper for an entertainment machine (1) is provided. The topper includes a display comprising a screen (9) arranged such that an image projected onto one side of the screen may be viewed from the opposite side of the screen. The invention enables a display of a gaming machine or associated topper to be provided by a back projected image. This enables the display content to be changed without having to physically change the screen or any associated artwork. Screens on to which images can be back projected are much less costly than electronic displays and can easily be provided in any desired shape. A further topper for an entertainment machine is also provided, the topper including a display comprising a screen (9) onto which an image can be projected, and a projector (11) arranged to project an image onto the screen.

The present invention relates to a topper for an entertainment machine.

Entertainment machines, such as fruit machines, one-arm bandits, gaming machines and the like, are often provided with a topper, sometimes also referred to as a top box. The topper, as the name suggests, is mounted to the top of the machine. The topper typically comprises an enclosure housing a lamp. The front of the enclosure is formed by a sheet of glass or transparent plastics material on which artwork is printed to form a back illuminated sign. The purpose of the topper is to attract attention to and promote the game provided by the entertainment machine. The topper therefore displays artwork relating to the machine and is generally of a contrasting shape to main display areas of the machine, for example oval, circular or star shaped. Individual lamps, typically light emitting diodes, may be arranged around the periphery of a topper and illuminated in sequence to further attract attention to the entertainment machine.

For reasons of operator efficiency and increased appeal to the public, programmable, so-called server based, entertainment machines have become popular. With these machines the game offered by a machine can be changed by re-programming of the machine. However, once game content has been changed it is necessary to physically replace the artwork bearing part of the machine topper if the topper is still to correspond to the game offered by the machine. This is time consuming and inconvenient.

The problem could be overcome by incorporating an electronic display, for example an LCD or OLED display, such as are used to provide game content in programmable entertainment machines, in the topper. However, such displays can be costly and they are not readily available (if at all) in the wide variety of shapes preferred for toppers.

Embodiments of the present invention have been made in consideration of these problems.

According to a first aspect of the present invention there is provided a topper for an entertainment machine, the topper including a display comprising a screen arranged such that an image projected onto one side of the screen may be viewed from the opposite side of the screen.

Thus, the invention enables a display of a gaming machine or associated topper to be provided by a back projected image. This enables the display content to be changed without having to physically change the screen or any associated artwork. Screens on to which images can be back projected are much less costly than electronic displays and can easily be provided in any desired shape.

The screen may comprise a transparent or at least partially transparent sheet of material, for example glass or plastics material such as an acrylic of the type sold under the trade mark PLEXIGLASS. The screen preferably includes a rear projection surface. This may be provided by a rear projection film. The rear projection film may be adhered to one side of the screen. Alternatively, the rear projection film may be sandwiched between two layers of material forming the screen. One suitable rear projection film is that provided under the trade mark VIKUITI by 3M United Kingdom Plc.

The screen may have any suitable shape, for example circular, oval, star-shaped or trapezoidal, and may be flat or curved, for example concave or convex.

An image may be projected onto the screen by a projector. The projector may be mounted on the entertainment machine or topper, or separate to the entertainment machine or topper. The projector is preferably a digital projector, for example an LCD projector. The image to be projected by the projector onto the screen may be provided by the entertainment machine or a server to which the entertainment machine is connected. The projector may project a static or moving image onto the screen. The image projected onto the screen of one entertainment machine may be synchronized with an image projected onto the screen of one or more adjacent machines. The same image may be projected onto the screen of each machine. Or part of an image may be projected onto the screen of one machine and another part or parts of the image projected onto the screens of adjacent machines so that, together, the screens reproduce the whole image. This allows for a bank of entertainment to present a large screen for tournaments and progressive multi-player type games.

Providing for display of a projected image on an entertainment machine or topper enables the image to be changed together with game content. It also allows for moving images to be provided and for images to be displayed in a manner which has hitherto not been possible with conventional static illuminated displays.

According to a second aspect of the present invention there is provided a topper for an entertainment machine, the topper including a display comprising a screen onto which an image can be projected, and a projector arranged to project an image onto the screen.

The projector and screen may be arranged to display a front or back projected image. The projector may be mounted to the topper or to an entertainment machine associated with the topper.

In order that the invention may be more clearly understood embodiments thereof will now be described, by way of example, with reference to the accompanying drawings of which:

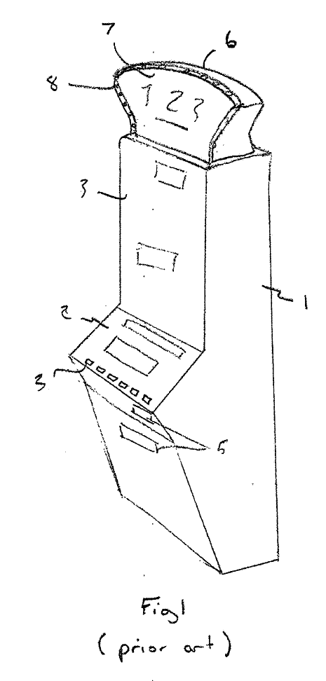

FIG. 1 is a perspective view of a conventional entertainment machine;

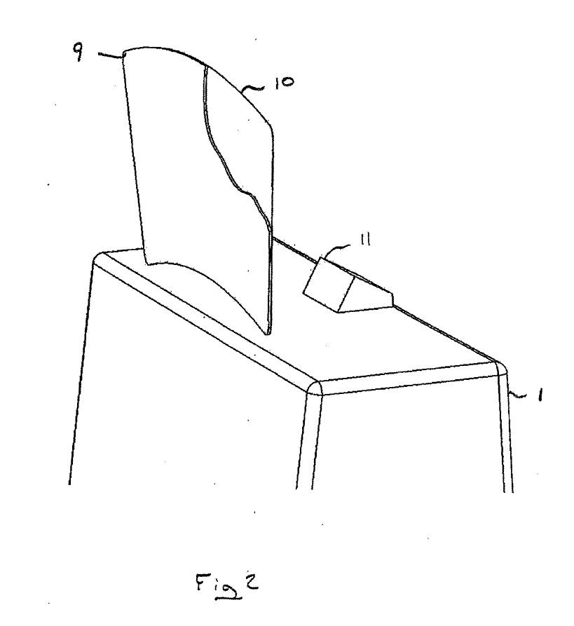

FIG. 2 is a partial, part cut-away view of an entertainment machine comprising a topper according to the invention; and

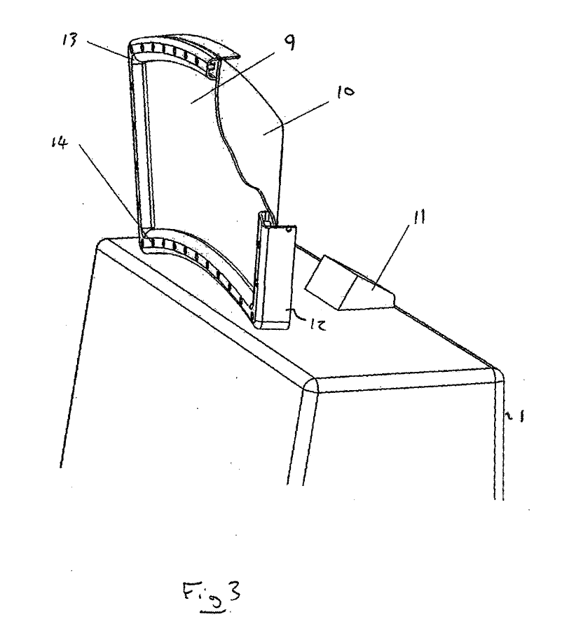

FIGS. 3 to 6 are similar views to FIG. 2 of alternative embodiments of the invention.

Referring first to FIG. 1 this shows a conventional entertainment machine with a conventional topper, also known as a top box. The machine comprises a cabinet 1. As is common with entertainment machines the cabinet provides primary 2 and secondary 3 game play surfaces. The two surfaces respectively provide primary and secondary game displays. The primary surface 2 additionally provides a number of player operable buttons 3. The cabinet also provides payment handling apparatus 5. To the top of the cabinet is mounted a conventional topper 6 formed by an enclosure housing a lamp which illuminates artwork printed onto a transparent sheet 7. The transparent sheet 7, in the illustrated example, has a curved top surface and a generally “fanned” shape and is surrounded by a plurality of LEDs 8 which are illuminated in sequence to give the effect of lights chasing each other around the display.

FIGS. 2 to 6 all show various embodiments of the invention in the form of toppers for entertainment machines. In each Figure only the upper part of an entertainment machine cabinet 1 is illustrated.

Referring to FIG. 2 a screen comprising a transparent sheet of substantially transparent acrylic plastics material 9 with an adhesive rear projection film 10 adhered to its rear surface, is mounted on top of an entertainment machine cabinet 1. The sheet 9 has straight sides which diverge slightly towards its top. The top is curved in a convex manner. The entire sheet is slightly concave to its front. Other shapes are, of course, possible and the sheet may be cut to any desired shape. The sheet is mounted in an upright configuration towards the front of the top of the entertainment machine. Also mounted to the top of the machine, behind and spaced apart from the screen is a projector 11. Any suitable projector may be used, for example an LCD projector. The projector is arranged to project an image onto the rear of the screen so that the projected image is visible from the front surface of the screen, that is to say the opposite surface to that on which the image is projected. With this embodiment the image preferably completely fills the screen giving an attractive and unusual appearance to the machine. Also, as the screen is separate from the projector this gives the arrangement the appearance of a floating independent screen. This effect could be increased by mounting the projector 11 to a structure other than the machine, for example to a wall or ceiling.

The relative position of the screen and projector 11 may be fixed. Alternatively, the mounting of the screen and/or projector may be adjustable to enable the relative position of the screen and projector to be varied to enable the size and position of an image projected on the screen to be adjusted.

Referring now to FIG. 3 an alternative embodiment is illustrated similar to that illustrated in FIG. 2 save that the screen is surrounded by a frame which includes a bezel in which a plurality of light emitting diodes, or other suitable lamps 14, are housed. The LEDs 14 illuminate the edges of the bezel. The LEDs may emit white or coloured light and may be illuminated steady, blinking or in a predetermined sequence to attract players to the machine. A similar effect might be obtained with the embodiment of FIG. 2 by projecting an image of lamps around the periphery of the screen.

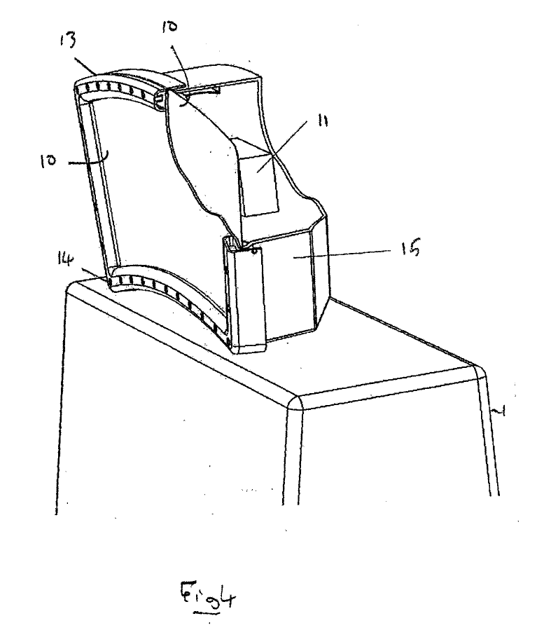

The embodiment illustrated in FIG. 4 comprises the screen surrounded by a frame similar to that illustrated in FIG. 3. In this embodiment, however, an enclosure 15 is mounted to the frame 13 and the projector 11 is mounted in the enclosure 15. The enclosure protects the projector and rear surface of the screen from the operating environment.

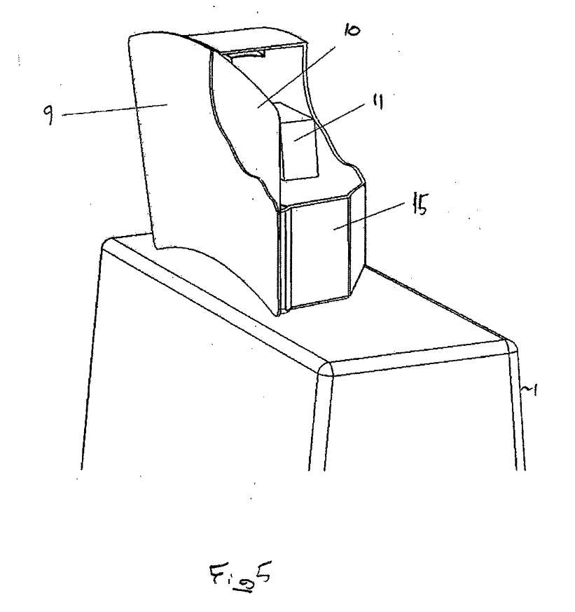

FIG. 5 illustrates an embodiment similar to that illustrated in FIG. 4, save that the frame 13 and bezel 14 are omitted. Here, the screen 9 is mounted to the enclosure directly.

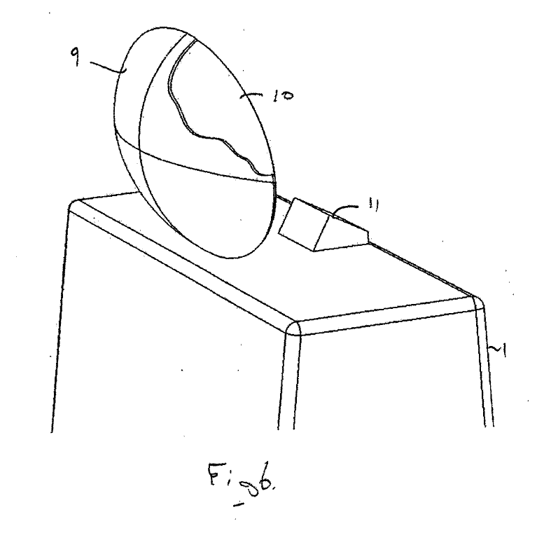

Referring to FIG. 6, in this embodiment the screen has a substantially circular outline shape and a generally parabolic surface. As with the embodiment of FIGS. 2 and 3 the projector 11 is mounted to the top of the entertainment machine spaced apart from the screen.

The above embodiments are described by way of example only. Many variations are possible without departing from the invention.

1. A topper for an entertainment machine, the topper including a display comprising a screen arranged such that an image projected onto one side of the screen may be viewed from the opposite side of the screen.

2. A topper according to claim 1 wherein the screen comprises a transparent or at least partially transparent sheet of material.

3. A topper according to claim 1 wherein the screen comprises glass or plastics material.

4. A topper according to claim 1 wherein the screen includes a rear projection surface.

5. A topper according to claim 1 wherein the screen includes a rear projection film.

6. A topper according to claim 5 wherein the rear projection film is adhered to one side of the screen.

7. A topper according to claim 5 wherein the rear projection film is sandwiched between two layers of material forming the screen.

8. A topper according to claim 1 wherein the screen has a circular, oval, star-shaped or trapezoidal shape.

9. A topper according to claim 1 wherein the screen is flat.

10. A topper according to claim 1 wherein the screen is concave.

11. A topper according to claim 1 wherein the screen is convex.

12. A topper according to claim 1 wherein an image is projected onto the screen by a projector.

13. A topper according to claim 12 wherein the projector is mounted on the entertainment machine.

14. A topper according to claim 12 wherein the projector is mounted on the topper.

15. A topper according to claim 12 wherein the projector is separate to the entertainment machine and to the topper.

16. A topper according to claim 12 wherein the projector is a digital projector.

17. A topper according to claim 12 wherein the image is provided by the entertainment machine.

18. A topper according to claim 12 wherein the image is provided by a server to which the entertainment machine is connected.

19. A plurality of entertainment machines each having a topper according to claim 12 wherein the image projected onto the screen above one entertainment machine is synchronized with an image projected onto the screen of one or more adjacent machines.

20. A plurality of entertainment machines according to claim 19 wherein the same image is projected onto the topper screen of each machine.

21. A plurality of entertainment machines according to claim 19 wherein part of an image is projected onto the screen of one machine and another part or parts of the image projected onto the topper screens of adjacent machines so that, together, the screens reproduce the whole image.

22. A topper for an entertainment machine, the topper including a display comprising a screen onto which an image can be projected, and a projector arranged to project an image onto the screen.

23. A topper according to claim 22 wherein the projector and screen are arranged to display a front-projected image.

24. A topper according to claim 22 wherein the projector is mounted to the topper.

25. A topper according to claim 22 wherein the projector is mounted to an entertainment machine associated with the topper.
